(19) United States
(12) Patent Application Publication
(10) Pub. No.: US 2013/0293932 A1
(43) Pub. Date: Nov. 7, 2013

(54) IMAGE CAPTURING DEVICE, IMAGE SCANNER, AND IMAGE FORMING APPARATUS

(71) Applicants: Atsushi SUGAI, Kanagawa (JP); Yoshiaki NAGAO, Kanagawa (JP); Tatsuaki NAGANO, Kanagawa (JP); Shohei SHINKAWA, Tokyo (JP); Masatoshi ISHIDA, Kanagawa (JP)

(72) Inventors: Atsushi SUGAI, Kanagawa (JP); Yoshiaki NAGAO, Kanagawa (JP); Tatsuaki NAGANO, Kanagawa (JP); Shohei SHINKAWA, Tokyo (JP); Masatoshi ISHIDA, Kanagawa (JP)

(73) Assignee: RICOH COMPANY, LTD., Tokyo (JP)

(21) Appl. No.: 13/855,084

(22) Filed: Apr. 2, 2013

(30) Foreign Application Priority Data
May 7, 2012 (JP) 2012-105851

(51) Int. Cl. H04N 1/047

(52) U.S. Cl. CPC H04N 1/047
USPC 358/406

(57) ABSTRACT

An image capturing device includes a frame; a light source provided in the frame to irradiate a target with light; an image sensor that receives light reflected by the target to capture an image of the target; an imaging lens unit formed of a plurality of lenses configured to focus the light reflected by the target on the image sensor; and reflecting mirrors to direct the light reflected by the target to the imaging lens unit. In the image capturing device, an image capturing position is corrected by changing a posture of the reflecting mirror relative to the frame of the image capturing device and a skewed image is corrected by changing the posture of the reflecting mirror relative to the frame of the image capturing device.

### CROSS-REFERENCE TO RELATED APPLICATION

The present application claims priority pursuant to 35 U.S.C. §119 from Japanese patent application number 2012-105851, filed on May 7, 2012, the entire disclosure of which is incorporated by reference herein.

### BACKGROUND

1. Technical Field

The present invention relates to an image capturing device, an image scanner, and an image forming apparatus.

2. Related Art

An image scanner is equipped with an image capturing device that acquires an image of a target object by using reflecting mirrors to direct light reflected by the target object onto an imaging lens that focuses the light onto an imaging device such as a Charge Coupled Device (CCD).

JP-3939908-B discloses an image scanner configured to form an image of the target object on the image capturing device using an imaging lens unit consisting of multiple lenses. Compared to a configuration using a single lens, a configuration using multiple lenses allows the focal distance to be shortened, thereby providing a more compact image scanner.

However, the image capturing position or document scanning position is deviated due to assembly errors of parts or components. In the conventional art, a position of the image capturing device is so corrected to a direction perpendicular to a light path incident to the image forming device so that the image capturing position has been corrected to a target image capturing position.

However, when the image capturing object is captured by the image capturing device with multiple lenses, the captured image receives an influence of aberration which is greater at a part away from a focal center of the lens. Adjusting the image capturing position by adjusting the position of the image capturing device as in the conventional method may deviate a center of the light-receiving surface of the image capturing device from the center of the lens and the light-receiving surface receives more light which has passed through a position away from the lens center, thereby making the captured image obscure with a low resolution.

Therefore, the present invention provides an optimal image capturing device capable of adjusting an image capturing position while preventing the resolution from degrading, and an image scanner and an image forming apparatus including the image capturing device.

### SUMMARY

The present invention provides an optimal image capturing device including a frame; a light source provided in the frame to irradiate a target with light; an image sensor that receives light reflected by the target to capture an image of the target; an imaging lens unit configured as a plurality of lenses to focus the light reflected by the target on the image sensor; and reflecting mirrors to direct the light reflected by the target to the imaging lens unit, in which an image capturing position of the image capturing device is corrected by changing a posture of the reflecting mirror relative to the frame of the image capturing device. Further, a skewed image is corrected by changing the posture of the reflecting mirror relative to the frame of the image capturing device.

These and other objects, features, and advantages of the present invention will become apparent upon consideration of the following description of the preferred embodiments of the present invention when taken in conjunction with the accompanying drawings.

### BRIEF DESCRIPTION OF THE DRAWINGS

FIG. 1 is an overview of a copier according to an embodiment of the present invention;

FIG. 2 shows a general configuration of the copier in FIG. 1;

FIG. 3 is an oblique view of an image scanner of the copier in FIG. 1;

FIG. 4 is an oblique view of a scanner illustrating an interior thereof;

FIG. 5 shows a general configuration of an image capturing unit;

FIG. 6 is a view illustrating a move of an integral part of an imaging lens unit and an image sensor;

FIG. 7 shows a general configuration of a driving system to drive the image capturing unit;

FIG. 8 is an enlarged view illustrating a main part of the scanner;

FIG. 9 shows a general configuration of reflecting mirrors and surrounding parts;

FIG. 10 is a cross-sectional view along a line A-A in FIG. 9;

FIG. 11 is a view seen from a direction B in FIG. 9;

FIG. 12 is an enlarged view illustrating another longitudinal side of the reflecting mirror;

FIG. 13 is a view illustrating oscillation of the reflecting mirror;

FIG. 14 is a view illustrating adjusting a position to scan an image; and

FIG. 15 is a view illustrating correction of a skewed image.

### DETAILED DESCRIPTION

Hereinafter, a first embodiment of an image forming apparatus (hereinafter, simply referred to a copier 1) employing an electrophotographic method to which the present invention is applied will now be described.

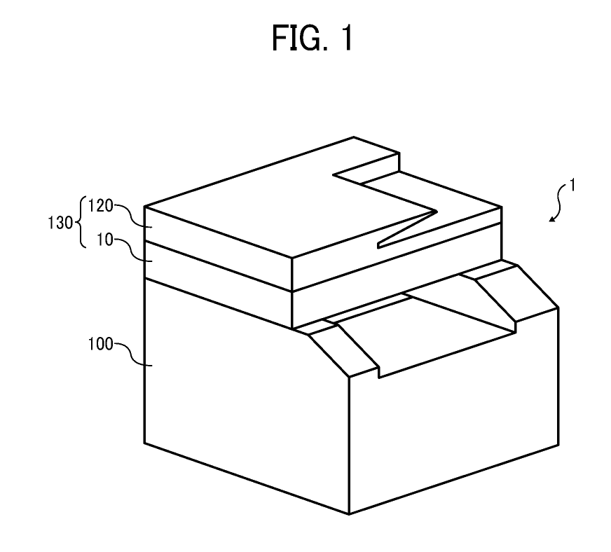

FIG. 1 is an oblique view illustrating an overall structure of the copier 1 as an image forming apparatus according to the first embodiment of the present invention.

The copier 1 includes a printer section 100 as an image forming unit disposed substantially in the center of the main body; and an image reading unit 130 disposed above the printer section 100. The image reading unit 130 includes a scanner 10 and an Automatic Document Feeder (ADF) 120.

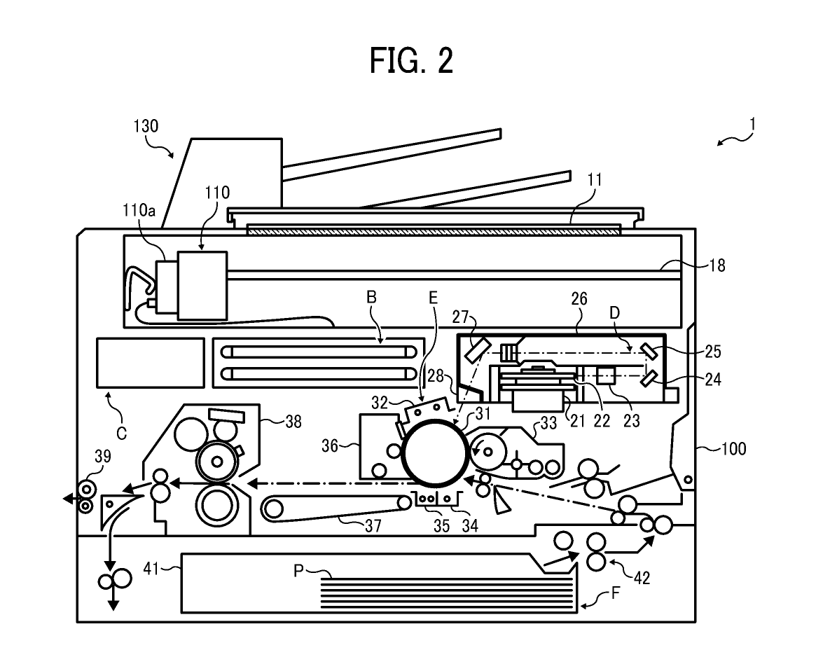

FIG. 2 shows a general configuration of the copier 1.

The printer section 100 includes an image processing section B, an image storage section C, an image writing section D, an image recording section E, and a sheet feeding section F.

The image recording section E includes a photoreceptor drum 31 as a latent image carrier, and parts disposed around the photoreceptor drum 31 including a charger 32, a developing device 33, a transfer device 34, a separator 35, and a cleaner 36. The image recording section E further includes a conveyance section 37, a fixing section 38, and a sheet discharge section 39 disposed downstream of the separator 35.

The sheet feeding section F includes a sheet feed cassette 41 to contain a transfer sheet P as a recording medium and a sheet feed mechanism 42 to separate and convey the transfer sheet P from the sheet feed cassette 41.

A surface of the photoreceptor drum 31, while rotating, is uniformly charged by the charger 32. The image reading unit 130 reads image information and the image processing section B performs image processing to the image information scanned by the image reading unit 130. Laser beams modulated according to the scanned image information are radiated onto the charged surface of the photoreceptor drum 31 from the image writing section D toward an axial direction of the photoreceptor drum to form an electrostatic latent image on the photoreceptor drum 31. Charged toner is adhered on the electrostatic latent image formed on the photoreceptor drum 31 at a developing area where the photoreceptor drum 31 and the developing device 33 are disposed opposite each other so that the electrostatic latent image is turned to be a toner image. The transfer sheet P is fed from the sheet feeding section F and is conveyed, at predetermined timing, to a transfer area where the photoreceptor drum 31 and the transfer device 34 are disposed opposite each other. The transfer device 34 supplies the transfer sheet P with potential voltage having a polarity opposite that of the toner image formed on the photoreceptor drum 31 to transfer the toner image formed on the photoreceptor drum 31 onto the transfer sheet P. Next, the transfer sheet P is separated from the photoreceptor drum 31 and is conveyed to the fixing section 38 by the conveyance section 37, where the toner image carried on the transfer sheet P is fused and fixed onto the transfer sheet P. The transfer sheet P is then discharged outside the image forming apparatus. The surface of the photoreceptor 31 after the toner image having been transferred via the transfer device 34 is cleaned by the cleaner 36, and thereby the toner remaining on the photoreceptor drum 31 is removed.

The image processing section B performs predetermined imaging processes responsive to an image signal sent from the image reading unit 130. Imaging processes performed in the image processing section B include: shading correction, brightness and density conversion, EE processing, character or halftone discrimination, filtering and scaling processes, copy γ correction, writing density correction, 2-beam control, error diffusion, data compression, and the like. Then, the image data processed by the image processing section B is temporarily stored in the image storage section C. The temporarily stored image data stored in the image storage section C is then output to the image writing section D. The image writing section D outputs writing light based on the stored image data from a semiconductor laser. The writing light from the semiconductor laser is scanned by a rotary multi-surface mirror or a polygon mirror 22 which is rotated by a drive motor 21, passes through an fθ lens, strikes a first mirror 24, strikes a second mirror 25, passes through a cylindrical lens 26, and strikes a third mirror 27, is emitted from a cover glass 28, and then irradiates the photoreceptor drum 31 disposed in the image recording section E.

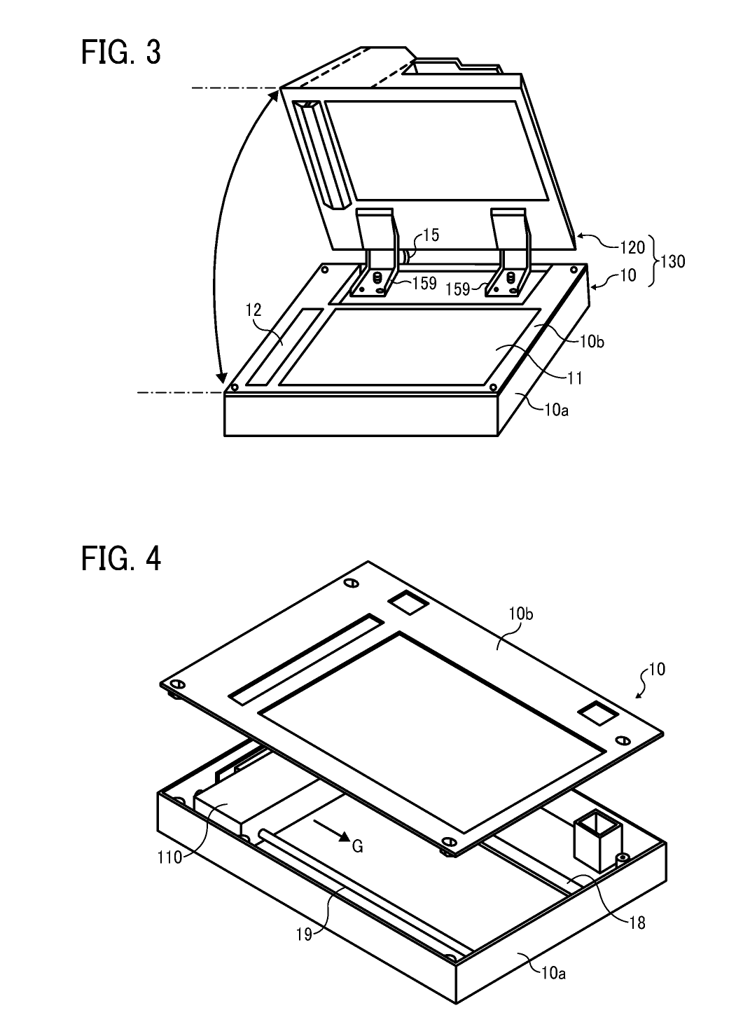

Next, the image reading unit 130 will now be described. FIG. 3 is an oblique view of the image reading unit 130.

As illustrated in FIG. 3, the ADF 120 disposed on the scanner 10 is supported by hinges 159 fixed to the scanner 10. The ADF 120 is configured as an openably closable cover. When the ADF 120 is open, a first contact glass 11 and a second contact glass 12 both disposed on a scanner cover 10b, which forms an upper part of the scanner 10, are exposed.

FIG. 4 is an oblique view of the scanner 10 illustrating an interior thereof.

As described referring to FIG. 4, the scanner 10 includes a substantially cube-shaped body or casing 10a containing an image capturing unit 110 and a scanner cover 10b so mounted on the casing 10b as to cover an upper face of the casing 10a. A guide rod 19 and a guide rail 18 are disposed collaterally in the casing 10a and the image capturing unit 110 is so supported by the guide rod 19 and the guide rail 18 as to be movable in an arrow G direction in the figure.

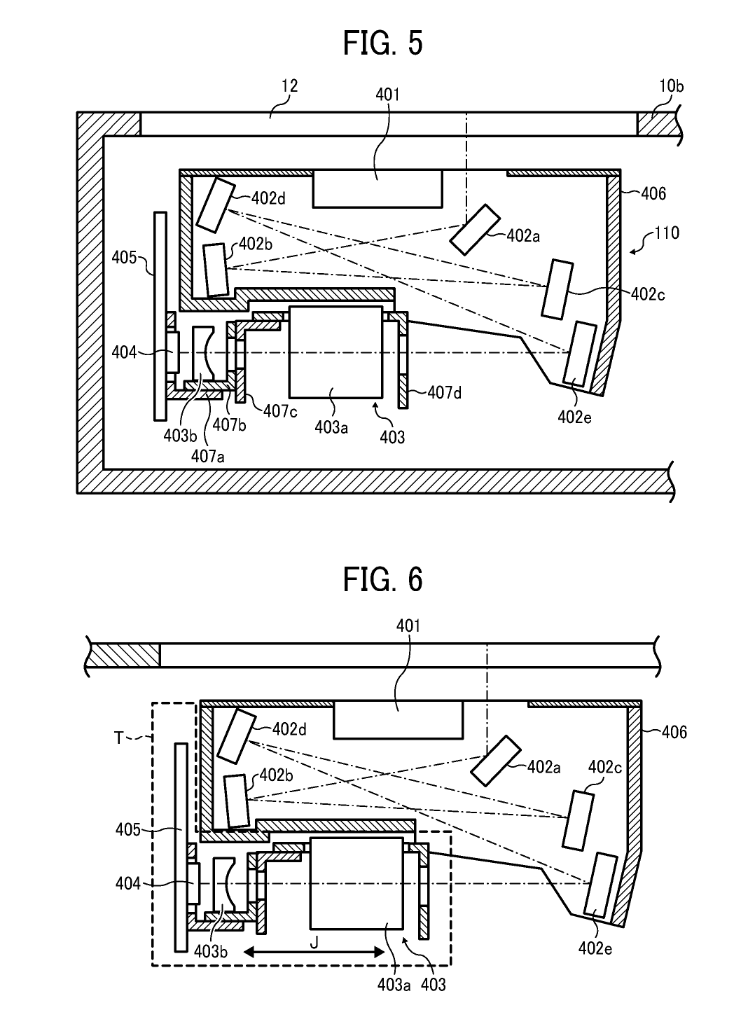

FIG. 5 shows a general configuration of an image capturing unit 110.

As illustrated in FIG. 5, provided in a frame 406 of the image capturing unit 110 are: a light source such as a xenon lamp, a light source unit 401 including an inverter circuit board which controls lighting of the light source; five reflecting mirrors 402a, 402b, 402c, 402d, and 402e configured to deflect the light reflected by an document as a target; an imaging lens unit 403 to focus the reflected light reflected by the reflecting mirrors; an image sensor 404 to optically convert the light focused by the imaging lens unit 304 into electrical signals for output; and a drive circuit board 405 to drive the image sensor 404 and output image signals based on the electrical signals output from the image sensor 404.

The imaging lens unit 403 includes a first lens group 403a disposed at a side of the reflecting mirror 402e and a second lens group 403b disposed at a side of the image sensor 404. The first lens group 403a is a positive power lens and the second lens group 403b is a negative power lens. In the illustrated example, the first lens group 403a is configured as a single lens, but may be configured as multiple lenses including one or more positive power lenses; for example, two to four lenses may be used. Because the imaging lens unit 403 is configured to include the first lens group 403a with a positive power and the second lens group 403b with a negative power, a color aberration can be corrected and a high resolution image can be formed on the image sensor 404. In addition, the focal distance can be shortened so that the image capturing unit 110 can be made compact. In addition, a so-called back focus being a distance from the second lens group 403b to the image sensor 404 can be shortened so that the image capturing unit 110 can be made compact.

A second plate 407b supports the second lens group 403b and the second lens group 403b is positioned at a target place relative to the image sensor 404, and the second plate 407b is fixed on a first plate 407a on which the drive circuit board 405 is fixed. A third plate 407c, on which a fourth plate 407d holding the first lens group 403a is mounted, is fixed on the second plate 407b. The fourth plate 407d is fixed on the third plate 407c with the first lens group 403a being positioned at a target place relative to the second lens group 403b. The fourth plate 407d is movably held by the frame 406. With this structure, an integral object T including the imaging lens unit 403 and the image sensor 404 as illustrated by a broken line in FIG. 6 can be moved in an arrow J direction being an optical axis direction incident to the imaging lens unit 403. As a result, without the relative positions of the first lens group 403a and the second lens group 403b of the imaging lens unit 403 and the image sensor 404 being changed, scaling correction can be performed.

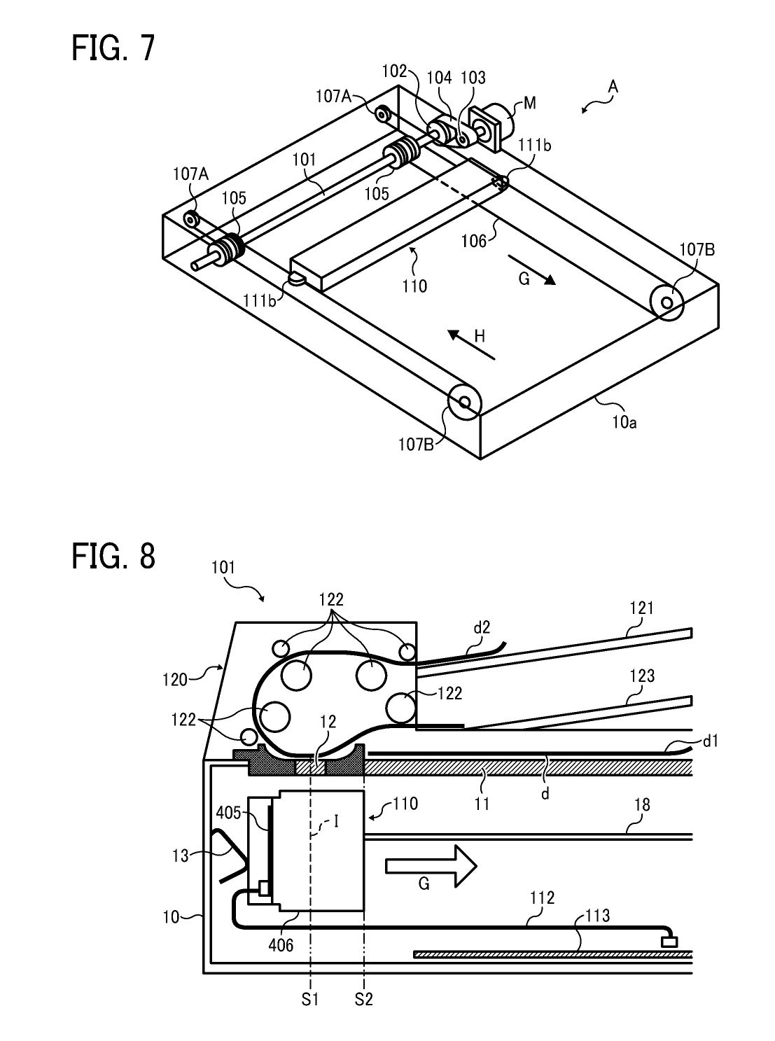

FIG. 7 shows a general configuration of a drive system to drive the image capturing unit 110.

A drive shaft 101 is rotatably supported in the casing 10a. A timing pulley 102 is fixed at an end of the drive shaft 101 and a timing pulley 103 is attached to the drive shaft 101 of a drive motor M. When the timing pulley 103 is driven to rotate by the drive motor M, the drive shaft 101 is rotated via a timing belt 104 wound around the timing pulley 103. Drive pulleys 105 are fixed around both ends of the drive shaft 101. An end of a flexible wire 106 wound several times is latched on each drive pulley 105. The flexible wire 106 is stretched over and wound around idle pulleys 107A and 107B. The image capturing unit 110 is latched at a predetermined position on the flexible wire 106 by an attachment member 111b.

As illustrated in FIG. 8, when the image capturing unit 110 is positioned at a place opposing the second contact glass 12, the image capturing unit 110 is at a home position S1. As previously shown in FIG. 7, when the drive pulley 105 rotates by the drive motor M, the flexible wire 106 is driven and the image capturing unit 110 is guided by the guide rail 18 and the guide rod 19 (see FIG. 4) along an image surface of an document d (see FIG. 8) placed on the first contact glass 11 as an document platen, and moves in an arrow G direction. The image capturing unit 110 starts to move from the home position S1 in an outward operation, i.e., when moving toward a scanning direction G, and quickly returns, without exposing an image, to the home position S1 in a return operation, i.e., when moving toward a scanning back direction H.

As illustrated in FIG. 8, the image signal output from the drive circuit board 405 is transmitted to a main control board 113 being a reading controller of the scanner 10 via a flexible flat cable 112 and is transmitted from the main control board 113 further to the image processing section B of the printer section 100 as illustrated in FIG. 2.

Further, as illustrated in FIG. 8, a document d2 set on a platen 121 is automatically conveyed one by one by a conveyance roller 122 and passes through a part above the second contact glass 12 of the scanner 10. In this case, the image capturing unit 110 stops at the home position S1 and reads the document d2 passing through the part above the second contact glass 12.

In the image capturing unit 110, due to assembly tolerances of the reflecting mirrors, a reading position or an image capturing position deviates relative to the target position or an image captured by the image sensor 404 is slanted (the image is skewed). Accordingly, adjusting so that the reading position becomes appropriate for the target position or the image skew does not occur is necessary before shipment. When the first lens group 403a with a positive power and the second lens group 403b with a negative power are used to focus an image on the image sensor 404, the light away from the center or the optical axis of the lens includes a greater aberration. As a result, when the center of the light-receiving surface of the image sensor 404 is deviated from the optical axis, the image sensor 404 receives much light in the position away from the center of the lens, thereby forming an obscure image with a low resolution. If the center of the light-receiving surface of the image sensor 404 is precisely aligned with the center of the first lens group 403a and the second lens group 403b so that the image sensor 404 can receive light passing through the center of the lens, an image with a high resolution can be obtained.

In the conventional apparatus, an image is formed using a single image forming lens focusing light on the image sensor, and the image capturing position and the skewed image were corrected by adjusting the position of the image sensor 404. In this method, the center of the light-receiving surface of the image sensor 404 and the center of the first lens group 403a and the second lens group 403b are deviated, so that an obscure image with a low resolution is obtained.

By contrast, in the present embodiment, by changing the posture of the reflecting mirror 402e, the correction of the reading position or the correction of the skewed image can be performed.

Hereinafter, a specific description is given of an embodiment with reference to the drawings.

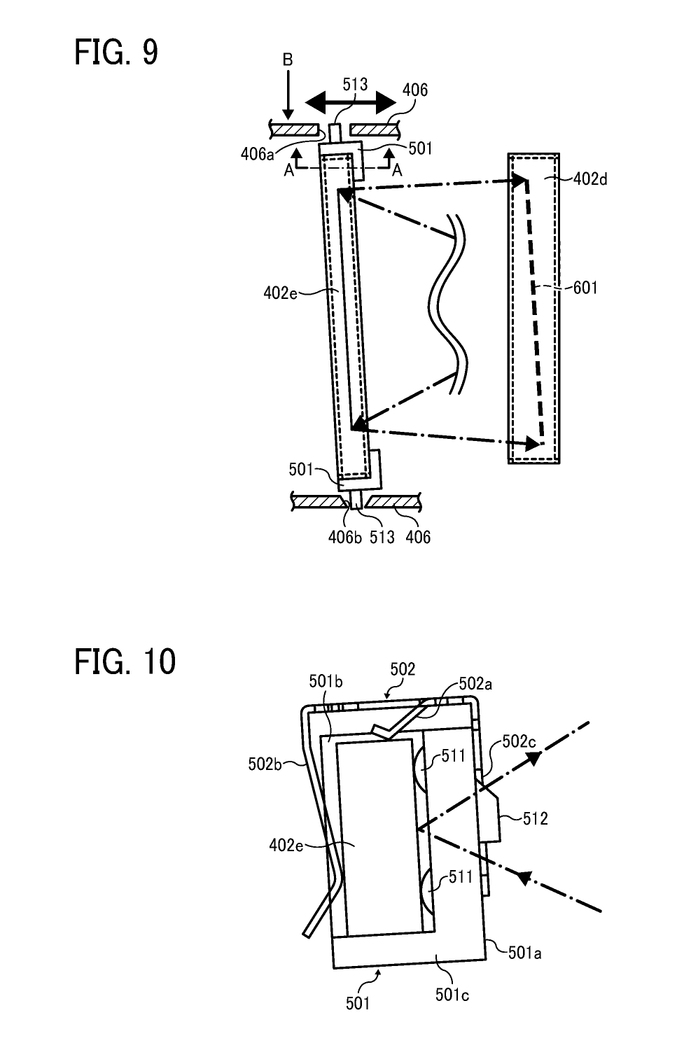

FIG. 9 shows a general configuration of the reflecting mirror 402e and surrounding parts; and FIG. 10 shows a cross sectional view along an A-A line in FIG. 9.

As illustrated in FIG. 9, both ends of the reflecting mirror 402e in the longitudinal direction, i.e., in the main scanning direction, are held by a mirror holder. As illustrated in FIGS. 9 and 10, the mirror holder 501 includes an opposed member 501a to be opposed to a reflecting surface of the reflecting mirror 402e; an end opposed member 501b opposed to an end surface of the reflecting mirror 402e; and a bottom opposed member 501c opposed to a bottom surface of the reflecting mirror 402e. The bottom surface is an end of the reflecting mirror 402e in the shorter direction or the sub-scanning direction. Projections 511 are disposed on the surface of the opposed member 501a opposed to the reflecting surface of the reflecting mirror 402e. The projections 511 contact the reflecting surface of the reflecting mirror 402e and position the reflecting mirror 402e. A latch member 512 is disposed on an opposite surface of the opposed member 501a opposed to the reflecting surface of the reflecting mirror 402e and latches a mirror pressing member 502.

As illustrated in FIG. 10, the mirror pressing member 502 includes a first leaf spring 502a and a second leaf spring 502b. The first leaf spring 502a presses an upper surface of the reflecting mirror 402e against the side opposite the bottom of the mirror holder 501. The second leaf spring 502b presses a back of the reflecting surface of the reflecting mirror 402e against the opposed member 501a of the mirror holder 501. The mirror pressing member 502 further includes a latch hole 502c to latch the latch member 512.

As illustrated in FIG. 10, the latch hole 502c of the mirror pressing member 502 is inserted to the latch member 512 of the mirror holder 501 so that the latch hole 502c and the latch member 512 are engaged with each other and the first leaf spring 502a presses an upper surface of the reflecting mirror 402e toward the bottom opposed member 501c. With this structure, the bottom surface of the reflecting mirror 402e is pressed against the bottom opposed member 501c so that the reflecting mirror 402e is held to the mirror holder 501 so as not to move vertically in FIG. 10. In addition, the second leaf spring 502b presses the back surface of the reflecting mirror 402e against the opposed member 501a. With this structure, the reflection surface of the reflecting mirror 402e is pressed against the projections 511 for positioning so that the reflecting mirror 402e is kept from moving horizontally in the figure.

As illustrated in FIG. 9, a column-shaped projection 513 is disposed on a surface of the end opposed member 501b of the mirror holder 501, i.e., on the surface opposite the opposed surface of the end surface of the reflecting mirror 402e.

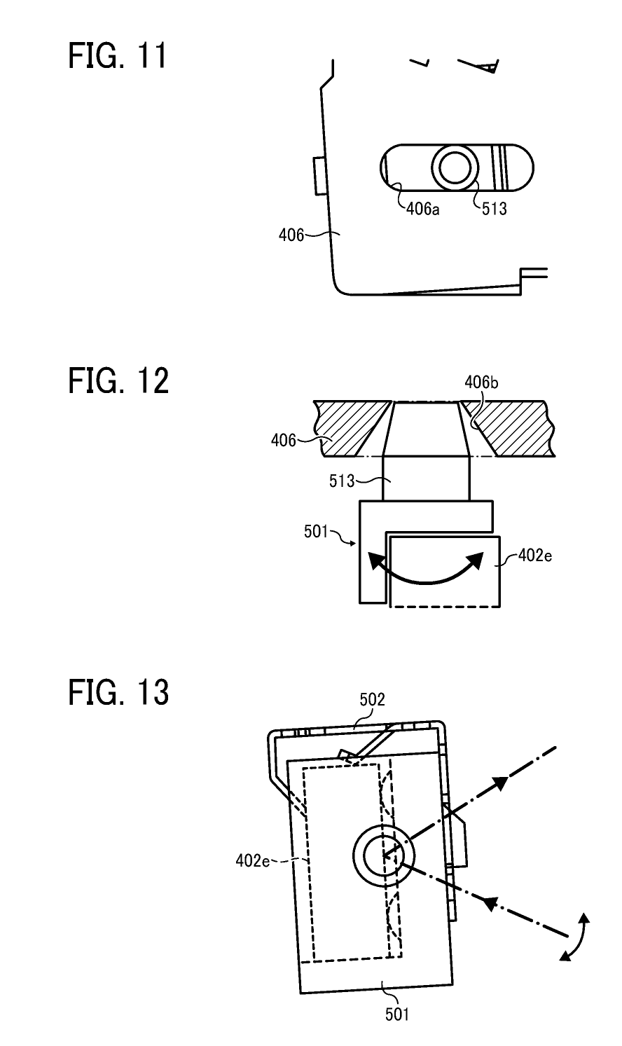

FIG. 11 shows a view seen from a direction B in FIG. 9.

As illustrated in FIGS. 9 and 11, a slot 406a extending laterally in the figure is formed on a side plate of the frame 406 at one end in the longitudinal direction of the reflecting mirror 402e. The projection 513 of the mirror holder 501 holding the one end in the longitudinal direction of the reflecting mirror 402e is inserted into the slot 406a.

FIG. 12 is an enlarged view illustrating another end in the longitudinal direction of the reflecting mirror 402e.

As illustrated in FIG. 12, a slot 406b is disposed on a side plate of the frame 406 at another end in the longitudinal direction of the reflecting mirror 402e. The slot 406b has a diameter gradually increasing toward the mirror holder 501. Another projection 513 of the mirror holder 501 to hold another longitudinal end of the reflecting mirror 402e is inserted into the slot 406b.

In the present embodiment, each cylindrical projection 513 is inserted into the slots 406a and 406b respectively, the reflecting mirror 402e is so mounted to the frame 406 as to rotate around the longitudinal axis of the reflecting mirror 402e. As a result, as illustrated in FIG. 13, the reflecting mirror 402e can be oscillated with the cylindrical projection 513 set as a supporting point.

FIG. 14 is a view illustrating adjusting a position to read an image.

As illustrated in FIG. 14, the reflecting mirror 402e is oscillated about the cylindrical projection 513 as a support point and a posture of the reflecting mirror 402e is shifted as illustrated by a broken line in the figure so that a reading position moves from a point C to a point D. Thus, the reading position can be corrected to a target reading position by oscillating the reflecting mirror 402e.

Further, in the present embodiment, the slot 406b at an end of the frame 406 is formed as a long slot and the slot 406b at an opposite end of the frame 406 is formed in a mortar shape. With this structure, the reflecting mirror 402e can be oscillated around a shorter side of the reflecting mirror 402e with the slot 406b set as a supporting point.

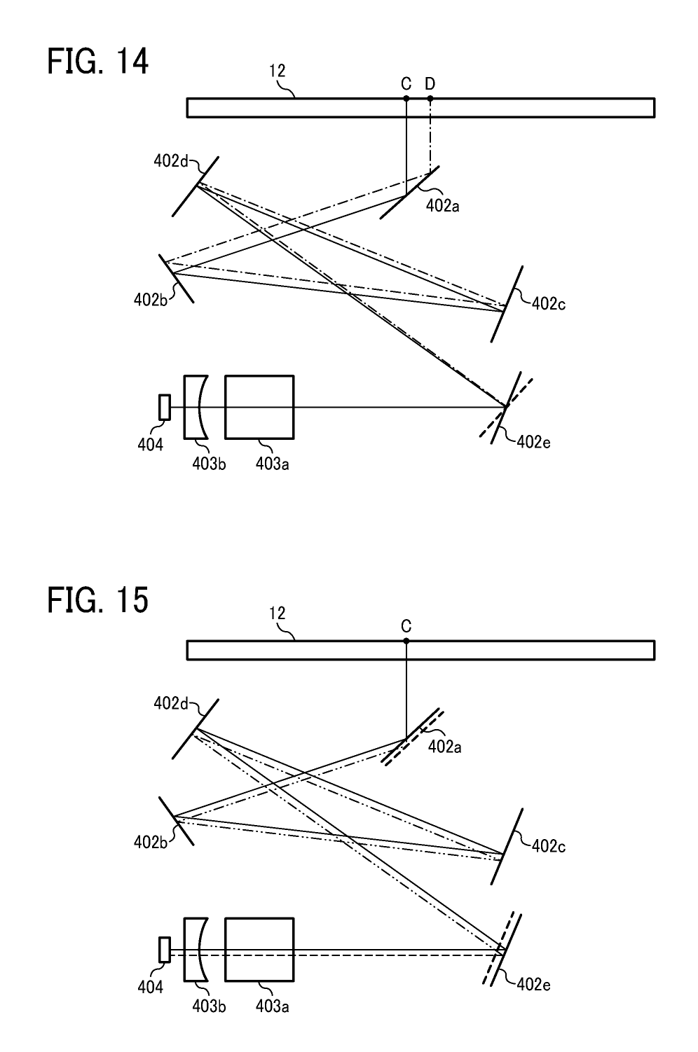

FIG. 15 is a view illustrating correction of a skewed image.

For example, as illustrated in FIG. 15, when assembly tolerances of the reflecting mirror 402a occurs and one end in the longitudinal direction is positioned at a position different from the other end as illustrated by a broken line in the figure, the image at one end in the longitudinal direction is incident at a lower position of the image sensor 404 compared to the image at the other end. As a result, the image is skewed, that is, one end of the image is lower than the other. Then, as illustrated by the broken line of FIG. 15, by shifting one end of the reflecting mirror 402e toward the focusing lens unit 403, the light can be vertically incident at the same position. Thus, a skewed image can be corrected.

In the present embodiment, because the slot 406b is formed in a mortar shape, the image skew can be corrected using the end portion as a support point, thereby making correction of the image skew easier.

Further, in the present embodiment, the correction of the image skew and the correction of the image capturing position can be simultaneously performed using the reflecting mirror 402e. When adjusting a skewed image, there is a case in which the image capturing position deviates from a target position. When the correction of the image skew and the correction of the image capturing position are performed by using different mirrors, respectively, the correction of the image capturing position needs to be performed with a mirror after having corrected the image skew with another mirror, thereby making the correction complicated. However, in the present embodiment, because the correction of the image skew and the correction of the image capturing position are performed using the reflecting mirror 402e, the both corrections can be simultaneously performed, thereby simplifying the correction operation.

When the posture of the reflecting mirror 402e is changed for the correction of the reading position, a scaling error is generated. In this case, after the correction of the reading position, as described by referring to FIG. 6, an integrated member T including the imaging lens unit 403 and the image sensor 404 is moved in an arrow J direction, i.e., an optical axis direction of a light incident to the imaging lens unit 403, to correct the scaling error. After the image skew correction, a scaling error deviation occurs. Therefore, the integrated member T can be mounted such that the integrated member T can oscillate along a shorter side of the frame 406. With this structure, the scaling error deviation after the image skew correction can be corrected.

In the present embodiment, because the reading position can be corrected by adjusting the posture of the reflecting mirror 402e, a center of the light-receiving surface of the image sensor 404 does not deviate from the center of each of the lenses. Thus, even after the reading position correction, image data with a high resolution can be obtained.

Correction of the reading position and the image skew is performed before shipping from the factory. After completion of the correction of the both, the slots 406a and 406b are coated with an adhesive and each projection 513 is fixed to the slot 406a or 406b. Because the parts and components are fixed by an adhesive after correction, the posture of the reflecting mirror 402e does not change when the apparatus receives any shock or vibration during the delivery. Further, any deviation of the reading position from the target reading position or the image skew can be prevented from occurring. Further, fixation with an adhesive can reduce a number of parts used compared to a case using a fixing member such as a screw and prevent an increase in the weight of the apparatus.

In the above embodiment, the posture of the reflecting mirror 402e is corrected so that the image skew correction and the reading position correction are performed; however, alternatively, each of the reflecting mirrors 402a, 402b, 402c, 402d can be used for correction.

Additional modifications and variations of the present invention are possible in light of the above teachings. It is therefore to be understood that, within the scope of the appended claims, the invention may be practiced other than as specifically described herein.

What is claimed is:

1. An image capturing device comprising:
a frame;
a light source provided in the frame to irradiate a target with light;
an image sensor that receives light reflected by the target to capture an image of the target;
an imaging lens unit configured as a plurality of lenses to focus the light reflected by the target on the image sensor; and
reflecting mirrors to direct the light reflected by the target to the imaging lens unit,
wherein an image capturing position of the image capturing device is corrected by changing a posture of the reflecting mirror relative to the frame of the image capturing device.

2. The image capturing device as claimed in claim 1, wherein a skewed image is corrected by changing the posture of the reflecting mirror relative to the frame of the image capturing device.

3. The image capturing device as claimed in claim 2, further comprising a reflecting mirror holder mounted to the frame of the image capturing device to hold both longitudinal ends of the reflecting mirror in a main scanning direction perpendicular to a sub-scanning direction,
wherein the reflecting mirror holder is movable about the main scanning direction and at least one end of the reflecting mirror holder in the main scanning direction is movable about the frame of the image capturing device.

4. The image capturing device as claimed in claim 3, wherein the reflecting mirror holder includes projections protruding in the main scanning direction at both longitudinal ends of the reflecting mirror holder,
wherein the frame further comprises:
a slot disposed at one end in the main scanning direction of the reflecting mirror, into which one of the projections of the mirror holder disposed at one end in the main scanning direction of the reflecting mirror is inserted; and
a mortar-shaped slot disposed at the other end in the main scanning direction of the reflecting mirror, into which another projection of the mirror holder disposed at the other end in the main scanning direction of the reflecting mirror is inserted.

5. The image capturing device as claimed in claim 3, wherein the reflecting mirror holder is mounted to the frame of the image capturing device with an adhesive.

6. The image capturing device as claimed in claim 1, wherein the imaging lens unit and the image sensor are configured as a single integrated unit and move in a direction parallel to an optical axis of the light incident on the imaging lens unit.

7. An image scanner comprising:
a light source to irradiate a surface of a document with light; and
an image sensor as claimed in claim 1, to capture light reflected by the surface of the document.

8. An image scanner as claimed in claim 7, further comprising a document feeder to convey the document to a document platen.

9. An image forming apparatus comprising:
an image scanner as claimed in claim 8, to scan an image of a document; and
an image forming device to form an image scanned by the image scanner on a recording medium.
